(19) United States
(12) Patent Application Publication
(10) Pub. No.: US 2001/0030611 A1
(43) Pub. Date: Oct. 18, 2001

(54) Checklist device

(76) Inventor: James D. O'Rourke, Pewaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 09/796,070

(22) Filed: Feb. 28, 2001

Related U.S. Application Data
(60) Provisional application No. 60/186,540, filed on Mar. 2, 2000.

(51) Int. Cl. H04Q 1/00

(52) U.S. Cl. 340/825.25

(57) ABSTRACT

A device for administering checklists to a user requires positive confirmation that each step of the checklist has been performed before it will proceed to the next step. In one form, positive confirmation is provided by a check button, following the actuation of which the device can be advanced to state the next step by pressing a playback button. In another form, the device is voice actuated, so the user speaks one or more certain words, at least one of which is in the step as stated by the device, and the device detects the correct word(s) and proceeds to the next step. In addition, emergency checklists are directly accessible by pressing a speed button or by speaking the name of the emergency checklist.

### CROSS REFERENCE TO RELATED APPLICATIONS

This claims the benefit of U.S. Provisional Patent Application No. 60/186,540 filed Mar. 2, 2000.

### STATEMENT REGARDING FEDERALLY SPONSORED RESEARCH OR DEVELOPMENT

Not applicable.

### BACKGROUND OF THE INVENTION

1. Field of the Invention

This invention relates to a device for maintaining and executing a checklist device for aviation or other purposes.

2. Discussion of the Prior Art

Prior to each flight, a pilot is required by regulations to perform a check of the aircraft, and this is currently done using a written checklist, such as on a paper and clipboard or on a computer display. The pilot may also add items to check to the checklist. If there are two pilots, they typically will perform the checklist together, one reading the list and the other doing the checking and stating when each check is complete. If there is only one pilot, the pilot does it alone, checking each item one by one by placing a check mark with a pen or by inputting to a computer. The list may be checked by a regulating authority if there is some abnormality with the flight or some question arises.

As currently performed, all steps of the checklist are typically displayed to the pilot from start to finish of the procedure. As a result, it is possible to skip around in order of checking or to inadvertently miss a step. Displaying all steps at the same time also tends to hasten the checking procedure, which can result in errors.

U.S. Pat. No. 3,713,090 discloses an aircraft checklist device which repeats steps to the pilot, but the pilot need only press a single button to advance from one step to the next. In addition, an emergency sensor is used to put the device into emergency mode. The sensor may fail or may not address the true source of the emergency.

### SUMMARY OF THE INVENTION

The invention provides a device which facilitates and reinforces checklist procedures used by pilots or others who are required to perform a series of steps. The hand held or panel mounted device audibly instructs the user of each item on the checklist, in order. After giving each instruction, the device waits for the user to make a positive indication to the device that the item has been checked. When the correct indication is received by the device, the device states the next step and waits for a positive indication that that step has been checked. This continues, with the unit requiring a confirmation that each step is performed before moving onto the next step, until the entire checklist has been performed.

A hand held version of the device has inputs to receive headset plugs and an output cord to be plugged into the aircraft□s instrument panel. The device may contain digital recording electronics. The pilot or owner/operator of the aircraft records the checklist(s) by plugging a headset into the device and reading the checklist items which will be recorded on the device through the headset microphone. Once recorded, the checklist items can be replayed one by one as previously mentioned. Once recorded, it will not be necessary to repeat the recording process unless there is a change to the checklist.

The handheld version of the device may take a form similar to a hand held micro cassette or digital audio or voice recorder. In one form, the device has one button for item by item playback, and pressing that button plays back only one item, and a separate button for indicating that an item has been checked. Pressing this button is required before the device will move on to the next item to be checked. In addition, after pressing this button, the unit can audibly confirm to the pilot that the item has been checked, and the date and time of checking can be automatically recorded on the memory media (i.e., magnetic tape or digital memory) of the device for the item checked. The device also has a button to reset it to the top of the checklist. For recording, the device has a button to record one item at a time, and preferably this recording is capable of inserting an item between two already existing items. This could be done digitally, or could be done using magnetic tape if blank tape was left between items in the initial recording.

A panel mounted device of the invention may be similar to the hand held device, but adapted for mounting on the aircraft panel. In addition, the device could be incorporated into an aircraft stand-alone intercom system. As stated, regardless of the form, these devices may have jacks for receiving inputs from the user's headset microphone (for recording) and outputting sounds to the headphone earphones. These units could also be provided with their own microphone built-it and/or with a speaker for outputting sounds.

In an especially useful form, the device is voice activated by the user and automatically recognizes speech as the confirmation to proceed to the next step. In this form, the user must state one or more certain words to confirm that the step stated by the device has been performed. In this form, it is preferred that the user state “Checked ______” where the blank space is filled in with one or more operative words from the step previously stated by the device.

In another preferred aspect, the device has emergency checklists stored which are accessible either from speed buttons that go directly to the emergency checklist, or are accessible by stating the name of the emergency checklist, e.g., “engine out”, and the unit jumps directly to the top of that list.

### BRIEF DESCRIPTION OF THE DRAWINGS

FIG. 1 is a front plan view of a hand held checklist device of the invention;

FIG. 2 is a right side plan view of the device of FIG. 1;

FIG. 3 is a left side plan view of the device of FIG. 1;

FIG. 4 is a front plan view of a second embodiment of a checklist device of the invention; and

FIG. 5 is a hardware block diagram of the circuit for the second embodiment.

### DETAILED DESCRIPTION OF THE PREFERRED EMBODIMENT

FIG. 1 illustrates a front plan view of a hand held unit 10 of the invention which contains batteries and electronics (not shown) for performing the functions of the checklist, described above. Alternatively, the unit could be part of the instrument panel of the aircraft. The unit 10 illustrated is for digital recording. If analog recording were used, for example using a micro cassette tape, a tape drive mechanism would also be included. Tape or removable digital recording magnetic media is preferred for practicing the invention since it can be preserved for maintaining a checklist record, while reusing the basic unit 10.

Optionally, the unit 10 may be provided with a speaker 12 for outputting sounds and a microphone 14 for inputting them. The device 10 can receive audible inputs from the user by the user speaking into either the microphone 14 or the user's headset microphone, and the device 10 produces audible outputs to the user either through the speaker 12, the user's headset or through the aircraft instrument panel speaker.

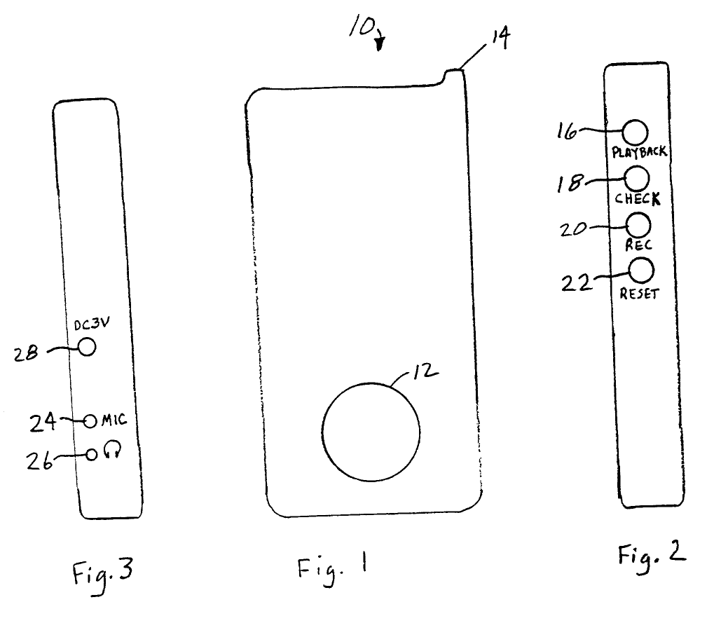

Referring to FIG. 2, the unit 10 has four buttons 16, 18, 20, 22 for operating it. The checklist is created by the pilot or other user pressing record button 20 and then speaking a single checklist item into his headset microphone, if it is connected to microphone jack 24, or into the microphone 14. The unit will stop recording after the pilot stops speaking, or if the pilot presses the record button again. This is repeated for each checklist item until the entire checklist is completed. If after the checklist is completed another item is desired to be added somewhere in the middle of the list, the pilot jogs forward to the place where the new item is to be inserted by using the playback and check buttons, and records it there.

Pressing button 16 once causes the unit 10 to play a single checklist item, in the order it was recorded. The pilot listens via his headset connected to jack 26 or through the speaker 12. After it plays the item, the unit stops, and waits for the pilot to press the check button 18. At that point the unit may give an audible indication to the pilot that the item has been checked. To proceed to the next item to be checked, the pilot presses the playback button 16 again and this cycle is repeated until the entire checklist is completed. To cause the unit to proceed to the next step, the check button 18 must be pressed; only pressing the playback button will not cause the unit to proceed to the next step, but could, for example, cause the unit to repeat the last step, or it could stay silent, or inform the user to confirm checking of the last step before proceeding to the next step.

The unit 10 could be voice activated in one or more ways. For example, voice activation could replace the function of any or all of the buttons 16, 18, 20, 22.

The unit may be provided with an internal clock and may record the date and time that the check button 18 was pressed for each item checked. This could then be used as part of a flight log and checked if any questions ever arose.

Pressing the reset button 22 causes the unit to return to the top of the checklist and erase all entries indicating a check has been completed, if any such entries were recorded by the unit. A cover (not shown) may be provided over the button 22 to prevent accidental pressing, since any recorded indications should be preserved at least until the flight is over.

Jack 28 is provided for recharging the batteries or providing a plug-in power source.

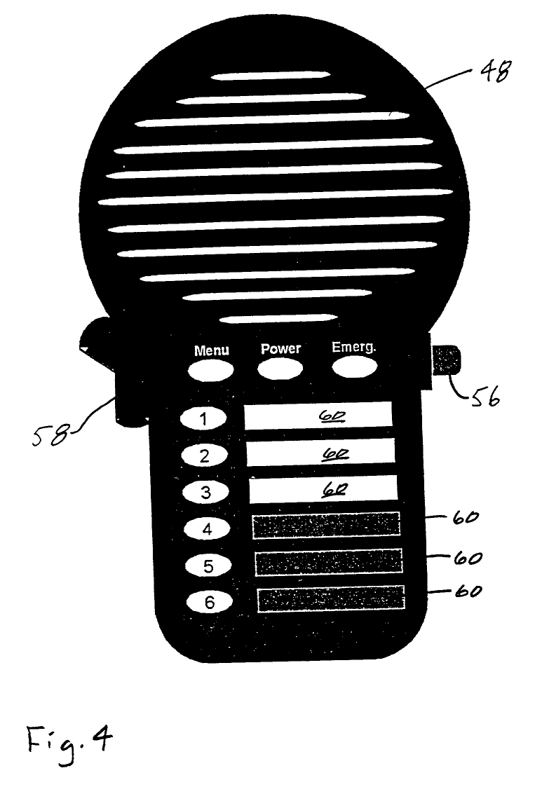

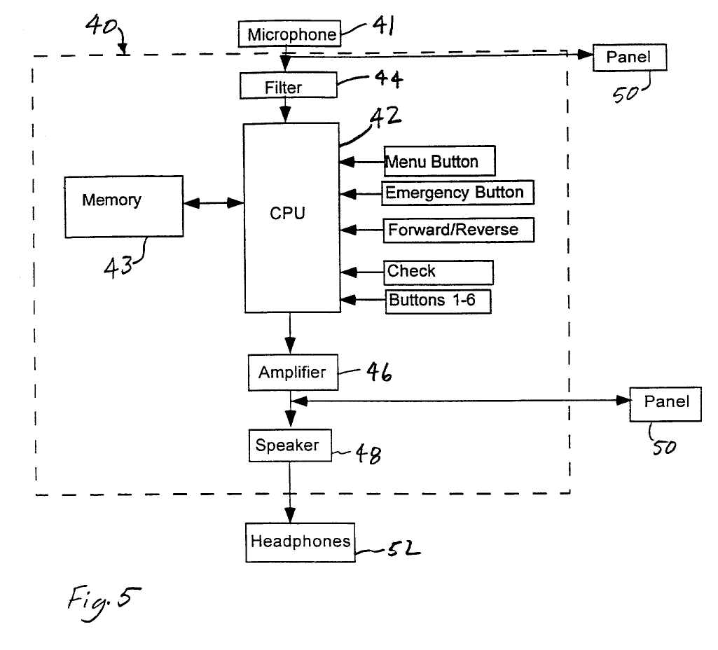

A second embodiment 40 of the invention which is particularly adapted for voice confirmation is illustrated in FIG. 4. The device 40 has different controls than the device 10, but like the device 10 would have headset and microphone jacks, a jack for connection to the instrument panel and power jacks, if desired.

Circuitry for the embodiment 40 is illustrated in FIG. 5. As illustrated, the device 40 is a digital device, having a digital signal processor chip 42. For example an Intel StrongARM SA-1110 chip could be used. A battery powered power management circuit (not shown) would also be included, for powering the unit 40, and a clock could be included for recording the date and time that each step of a checklist is performed. Memory 43 would be digital memory, for example a combination of SDRAM and flash memory. In addition, although not shown, a storage device like a small hard disk or a storage device having removable media may be used, particularly if the device is to record the date and time when particular steps are performed, or whether they were performed.

Alternatively, a Windows CE pocket personal computer could be used to practice the invention, by running a program on the pocket computer which executes the invention. Such a computer would not have the special purpose buttons which the devices 10 or 40 have, but the existing buttons of the pocket PC or menus of it could be programmed to perform the same functions. In particular, a program such as “fonix FAAST [symbol] Embedded” or “fonix FAAST [symbol] Windows CE”, depending upon the chosen platform of the device, are available from Fonix Corporation of Salt Lake City, Utah (www.fonix.com). These are software development programs containing automatic speech recognition and text-to-speech technology for embedded systems. These programs are Windows based and present a visual interface and graphical representation of elements necessary to create a speech-enabled embedded application. They can be used to write software that will recognize speech which is input by the user through the microphone 41 to the device 10 or 40 (or a Windows CE computer) and will also output speech through the speaker of the device or to the headphones (or panel speaker) which are connected to the unit.

In addition, as shown in FIG. 5, the circuitry of the device 40 preferably includes an electronic filter 44 for filtering out the background noise around an aircraft, for example engine and wind noise, and distinguishing the spoken commands or speech from the background noise. In addition, an amplifier 46 may be necessary for a suitable output to the speaker 48, panel 50 or headphones 52.

Referring to FIGS. 4 and 5, the device 40 (or a Windows CE computer programmed with the same controls) has the following buttons (or other inputs in the case of a Windows CE computer): power, menu, power, emergency, buttons 1-6, checked button 56 and forward/reverse toggle button 58. To the right of each button 1-6 is a label 60 on which a user may write the list or function of that button, like speed dial buttons on a telephone.

The device 40, or Windows CE computer programmed with the same controls, operates as follows:

With the power on, when the menu button is pressed, the unit will state, which is output through the speaker 48 or the headphones 52, a menu with the following options: “To use a checklist, press 1; to create a checklist, press 2; to edit a checklist, press 3; to create an emergency checklist, press 4; to edit an emergency checklist, press 5.”

If the user presses 1, the device states, “Press forward or reverse to select your checklist”. The user will then press forward or reverse to toggle one by one through the checklists. For example, in the case of a device 40 set up for an aviator, one press forward of the switch 58 may cause the device to state, “Preflight Checklist”. With two presses forward the device may state, “Start-up Checklist”, three presses, “Run-up checklist”, etc., depending upon which checklists the user has recorded into the device. Alternatively, all of the checklists necessary for a flight may be recorded under one heading, or under one of the programmable buttons 1-6. However, the buttons 1-6 are best used for recording emergency checklists, such as “Engine out”; “Fire”; “Landing Gear Failure”, etc., since they provide a fast way to go immediately to those checklists.

When the user hears the name of the checklist he wants to administer, he presses the “check” button, and the device starts to go through the list. The device will say, for example, “Start-up checklist, item 1, check flaps”, or anything else that the user records into the device for that checklist. Because of the ability of the device to recognize speech, the device will not proceed to the next step of the list until the user speaks “checked flaps”, if the step being performed is “check flaps”. As explained above, when the device “hears” the user's confirmation, using the word “checked” along with the operative word in the step, i.e., the operative word is the word following “check” as spoken by the device—“flaps” in this case, the device proceeds to the next step. The device will not proceed to the next steps until it hears these precise words, although the accuracy with which it must hear them can be adjusted using the development software. Thus, only when the device hears “checked flaps”, will it proceed to the next step. When proceeding to the next step, the device preferably states, “next item” and then states the next step. If that step is “check landing gear”, the device will not proceed to the next step until it hears “checked landing gear”, etc. If any of the buttons are pressed, the device can be programmed to either do nothing (stay silent), repeat the step on which it is waiting for a confirmation, or inform the user to confirm the last step before proceeding to the next step.

Preferably, when running through a checklist, once a step is confirmed, the user can scroll back up through the checklist by pressing the reverse toggle. The user can then get back to the point in the list on which a confirmation is required by toggling forward without confirmation required, but once he gets to that point, the device will require verbal confirmation from the user before going to the next step in the list. If a user goes so far backward in a list as to go beyond the first step, the menu of lists is presented by the device which is similar to pressing the menu button, except preferably the user could still scroll forward to the point on the checklist at which he started scrolling backward. If he tried selecting a different checklist in this manner, verbal confirmations would be required to scroll through it.

If a user wants to go to a particular step of a checklist without confirming each step, the device is preferably programmed so that once the user is in a checklist, the user can press the reverse toggle switch 58 in combination with the check button 56, and the device will repeat the steps of the checklist starting at the last step, and will not require confirmation to move to the next preceding step. When the user gets to the desired point in the list, the user releases the check button 56. Then, to go forward through the list from that point, the user can press the toggle forward with switch 58 and the device 40 will require confirmation of each step before proceeding to the next step. The user can go backward in the list from that point by pressing the toggling in reverse with switch 58, and after having gone backward can return forward to that point by toggling forward, without having to confirm. However, to go forward from the point where the check button was released, verbal confirmations from the user would be required by the device 40. When the device gets to the last step of a list and receives confirmation, preferably the device states, “end of checklist”.

If a user wants to create a checklist after pressing the menu button, the user presses 2, as stated above. The unit then states to the user verbal instructions on how to create a list. The new list would be added at the end of the currently stored lists. The unit would state to the user, “State the name of the new list and press check when finished.” The user then states the name, which the unit records, and the user presses the check button 56, which tells the unit to stop recording and move on. The unit then states, “State each step and press check in between steps. After the last step, press check twice.” The user then states each step, e.g., “check fuel”, which the unit records, and presses check button 56 after each step. After the last step, the user presses check twice and the unit adds the new checklist to the menu.

As stated above, the user presses 3 after pressing menu to edit a checklist. The unit then states, “Press check when you hear the name of the checklist you want to edit”. The unit then states the names of the checklists from the menu and the user presses the check button 56 when the desired one is stated by the device 40. The device 40 then states, “Use the toggle to scroll to the insertion point where you want to add a step and press and release check. To delete a step, scroll to the point past the step and hold down check while toggling backward one step.” If a step is being added, after the user gets to the desired point and presses and releases the check button 56, the unit states, “State the step and press check when finished.” The user then does it and the device records the step and inserts it at the desired place.

If the user presses 4 after pressing menu, to create an emergency checklist, the device states, “Press the speed button under which you want to create your emergency checklist.” The user then presses the one of the buttons 1-6 under which he wants to create the list, and the device states, “State the name of the new list and press check when finished.” The user then states the name, which the unit records, and the user presses the check button 56, which tells the unit to stop recording and move on. The unit then states, “State each step and press check in between steps. After the last step, press check twice.” The user then states each step, e.g., “check parachute”, which the unit records, and presses check after each step. After the last step, the user presses check twice and the unit adds the new checklist in registration with the button number the user selected.

An emergency checklist is edited, after pressing menu, by pressing 5. After a user presses 5, the unit states, “Press the speed button number of the emergency checklist you want to edit”, and the user does so. The unit then states, “Use the toggle to scroll to the insertion point where you want to add a step and press and release check. To delete a step, scroll to the point past the step and hold down check whole toggling backward one step.” If a step is being added, after the user gets to the desired point and presses and releases the check button 56, the unit states, “State the step and press check when finished.” The user then does it and the device records the step and inserts it at the desired place.

If the user presses the emergency button, the unit will state, “Use the toggle to scroll through the emergency checklists. Press check when you reach the one you want to administer.” After this, the toggle is used to scroll through the emergency checklists and the list is administered in the same way that a regular list is administered, as described above in connection with pressing menu and speed button 1.

Preferably, if the user is at any step in a regular or emergency checklist and states “emergency” loudly, the device states, “Say yes or press check when you hear the list you want to administer” and the device would immediately start stating the names of the emergency list. When the device hears “yes” or the check button 56 is pressed, it starts going through the list. However, rather than requiring absolute confirmation using the correct words, it would proceed to the next step if it heard those words or “yes” or “OK” or “next”, or if the check button is pressed or if forward is pressed. No specific confirmation would preferably be required under emergency circumstances.

Also, preferably, if at any point the unit hears the specific name of an emergency checklist, e.g., “Engine out”, it immediately goes to the top of that list and starts administering it, as in the immediately preceding paragraph, proceeding to the next step if it heard the exact confirmation words or “yes” or “OK” or “next”, or if the check button is pressed or if forward is pressed.

Many different forms of electronic devices could be used to practice the invention, whether a dedicated device as are the devices 10 and 40 or a general purpose computer, as would be a pocket PC. The electronics themselves form no part of the invention; any such means which perform the stated functions being suitable.

Preferred embodiments of the invention have been described in considerable detail. Many modifications and variations to the preferred embodiments described will be apparent to those skilled in the art. Therefore, the invention should not be limited to the embodiments described, but should be defined by the claims which follow:

I claim:

1. A method of operating a checklist administration device, comprising the steps of:
a. storing the steps of a checklist in said device;
b. audibly outputting from said device a single step of said checklist to a user of said device;
c. pausing said device after said step is audibly output to wait for a confirmation input from the user which communicates to the device that the immediately preceding step has been performed;
d. receiving said confirmation input from said user and enabling audible output of the next step by the device in response to receipt of said confirmation input; and
e. audibly outputting the next step.

2. A method as in claim 1, wherein said confirmation input is provided by the user actuating a switch of said device, and the step of audibly outputting the next step is performed by the user actuating a different switch of said device.

3. A method as in claim 1, wherein said confirmation input is provided by the user audibly inputting to the device one or more certain words.

4. A method as in claim 2, wherein said one or more certain words include one or more certain words audibly output by said device in stating said single step.

5. A method of operating a checklist administration device, comprising the steps of:
a. storing the steps of a checklist in said device;
b. audibly outputting from said device a single step of said checklist to a user of said device;
c. pausing said device after said step is audibly output to wait for actuation by said user of a confirmation input switch of said device followed by actuation by said user of a playback switch of said device;
d. audibly outputting the next step after receiving actuation of said confirmation input switch followed by actuation of said playback switch.

6. A method of operating a checklist administration device, comprising the steps of:
a. storing the steps of a checklist in said device;
b. audibly outputting from said device a single step of said checklist to a user of said device;
c. pausing said device after said step is audibly output to wait for an audible input by said user of one or more certain words which confirm that said step has been performed; and
d. audibly outputting the next step after receiving said audible input from said user.

7. A method as in claim 6, wherein said one or more certain words include at least one word audibly output from said device in step b of claim 6.

8. A method as in claim 7, wherein said one or more certain words include the word “checked”.

9. A method as in claim 6, wherein said device starts audibly outputting the steps of an emergency checklist when a button for said emergency checklist is depressed.

10. A method as in claim 6, wherein said device starts audibly outputting an emergency checklist when the user audibly inputs the name of the emergency checklist to the device.
